(19) United States
(12) Patent Application Publication
(10) Pub. No.: US 2018/0210911 A1
(43) Pub. Date: Jul. 26, 2018

(54) Method and System for Interactive Notation, Text Data Storage and Management on a Mobile Device.

(71) Applicant: Oliver Wendel Gamble, New York, NY (US)

(72) Inventor: Oliver Wendel Gamble, New York, NY (US)

(21) Appl. No.: 15/412,497

(22) Filed: Jan. 23, 2017

(51) Int. Cl. G06F 17/30; H04W 4/12; H04L 29/08

(52) U.S. Cl. CPC G06F 17/30377; H04W 4/12; G06F 17/30477; H04L 67/06; H04L 67/1097

(57) ABSTRACT

A new Text Messaging System (Obexi Text) that enhances text messaging. The Obexi Text (OT) System eliminates the need for a user to searching through old text messages one by one to find specific information, no need for manually sorting through text messages to decide which ones to keep and which ones to delete to make room for new text messages, no longer a need to search your text messages to see what is new or worry about missing an important text message, or miss an appointment. Our improved Text Messaging application creating what we term long string data (LSD) out of text messages. LSD is created by converting the contents of both sent and received text message into a variety of fields that are stored in a record that will be stored in a table by a phone with the OT application. The OT application also has the ability enable the user to search the table of stored text messages, to delete old (outdated)/unwanted text messages, and enforce better texting protocol.

The present application claims the benefit of priority of provisional patent application Nos. 62/389,275, 62/494,861, and patent application Ser. No. 14/541,132, the disclosure of which is hereby incorporated by reference in its entirety for all purposes.

### SUMMARY OF THE INVENTION

The present invention relates generally to a method and system for improving the utilization of information obtainable from the utilization text messaging in general. Traditional Texting is limited in functionality by the nature of the text message being a sequence of captured and displayed strings. Current texting systems consist primarily of being able to manipulate data string: copy/cut and paste, delete and view. Some specialty text messaging apps may do other feats, but there is not new platform for text messaging until now. This change in the text message paradigm is possible by changing the nature of how text messages are perceived, and this is possible by changing the nature of how text messages are sent and received. By converting text messages to data to be stored in a table, text messages become something that is perceived as something that is reviewed and manipulated as opposed to something that is used/looked at once and eccentrically disposed as garbage.

Converting text messages into data that can be stored in a table opens the contents of a text message to a variety of functions and applications that cannot be applied to a text message stored as a string: time sensitive auto-deletion, creation of relations between all sent and received text messages, notifications of user interactions, and heads-up display of text messages with highlight to important ones. Deleting stored text messages is a time-consuming processing that involve's reviewing each message and deciding if you want to keep it or delete it to make room for new messages and/or clear up the clutter on your phone. Searching for information received in a text message is another time-consuming processing that involves looking at a lot of old text messages to find what you want (and possibly being distracted by what encountered while looking). As a record in a table, text messages can be easily search and/or set to be deleted if old and un-wanted. They can also be displayed in a time saving and efficient manner.

### DETAILED DESCRIPTION OF PREFERRED EMBODIMENT

Each Text Message handled by an OT application will be converted into data that can be stored as a record in a database file. In addition to the text information that comes in the body of the text message other data can be added to the record created from the text message: the phone number of origin can be extracted, and an editable search key can be added or extracted if already enclosed in the text message. The data created from the text message will primarily be of a text (alphanumeric string of characters and spacing), thus we termed this data Long String Data (LSD). As a record in a table stored in a database, the information that was contained in the text message is now searchable, actionable, and acquires a commercial value.

Text Messages (TM) are generally of a maximum length of 140 characters in length. OT will store each incoming and outgoing TM in a record that has 4 fields for the contents of incoming text messages and 4 fields for storing the contents of outgoing text messages. The contents of each text message is divided into segment of approximately 35 characters in length: some segments will be more than 35 characters in length, and other segments will be less than 35 characters in length. The division of the text message content will be such to avoid dividing the TM into four roughly equal length segments without splitting a word in the middle in the content of the text message, segmentation will occur in a blank space between words in the message. Each segment containing parts of a receive or send text message will be sequentially stored in specific fields in a record stored in a table store in a database. If the text message length is between 1 and 35 characters in length, the entire text message will be stored in the first field of the record; if the message is between 36 and 70 characters in length, the text message will be stored in the first and second field; if the text message is between 71 and 105 characters in length, it will be stored in the first, second, and third field; and if the text message is between 106 and 140 characters in length, the text message will be stored in the first, second, third, and forth field of the record. Each record in the table has fields that can hold both an incoming and an outgoing text message: a message and the reply to it. Each record can also have fields to hold other types of information that can be extracted from an incoming or outgoing text message (see FIG. 1). These field will can hold expiration date, creation (received/send) date, flags for executing certain activities, phone numbers, editable search key (field by which the record can be group/sorted), and other fields that are needed to perform functions in OT.

In an alternate embodiment, the entire text message may be stored in a single field, and software may be employed to display the field in a visually easy way to view, and extract information.

In an alternate embodiment fields and function can be augmented by customers using tools on the OT website, some other professional website, or a social website. They can add new fields load up new function by adding an additional library or app package to their phone.

The contents of each text message will then be scanned/filtered for flags and other data contained in the text message: i.e. phone number, alert flag, reply indicator flag, and activity triggers. Any recovered phone number, flag, and/or actionable triggers (triggers that will cause the OT application to execute a specific action at a specific time or event) will be stored in specific fields. The OT application will execute functions on these flags and phone number when determined appropriate.

The Editable Search Key, is a field that the user can use to classify, characterize, or identify the contents of the text message. This field is not part of the text message content, it is a field that is generally filled by the received of the text message, but it can also be forward as a flag in a advertising text message. The user can enter any word or group of words into this field and use it as a tag that can be search for, enabling the user to link un-related text message together in a way that make sense to them. The user can then run reports/search the text message table for all text messages with the same search key value (word/group of words). There will be other search keys that will allow the user to view the text messages stored on the mobile device in various grouping: date, phone number, name, grouping, alerts, or by any work that the user wants to search by or for.

The OT application allows the user to search their entire text message table (database) by several different fields, of which the granular is the most efficient. The granular search will search each field of the text messages stored in the text message table for the occurrence of a specific word (group of words).

OT application has the ability to search all of the records stored in the application, allowing the user to connect data from multiple origins: text messages from different people can be combined and searched. The newly created record in table containing the database of sent and received text messages can now be searched in a granular manner: all stored text message can now be searched individually for a specific word, regardless of their origin. The records created from different sources can also be cross related by the editable search key (aka: keyword).

This mean that you can search text messages from different people/companies for a word (piece of information). This key can be words, numbers or a combination of the two. The user will be able to search all of their sent and received text message for that key, enabling them to search Text Messages from multiple sources at the same time for the same wording. The database field system created under the OT system will allow users to screen incoming text message and disposition them: delete, read, and store for later actions. The editable search key allows the phone user to store the information under a word that best suits the information they are storing on their phone. Once the information is stored under a word that best describes it to the user, the user will be able to easily search and retrieve for it at a future date. By adding an editable search key and enhance data storage to Obexi Text, the user can create relational database search and reports on the contents of what was send and/or received in text messages.

In the preferred embodiment of Obexi Text, the user can use the OT application to send information from their cell phone to another cell phone regardless of the phone that they are communicating with having an OT application installed on it (FIG. 7b). OT using filters will be able to selectively respond to text messages: be able to automatically both acknowledge receiving a specific Text Message, and notifying the sender of the Text Message when the said Text Message actually read/viewed. OT will also be able to use filters to extract specific information from the body of the text message and store that information in specific pre-determined fields. This will enable the OT application to get information that can be used in or to trigger other functions within it.

In an alternate embodiment fields and function can be augmented by customers using tools the OT website. They can add new fields load up new function by adding an additional library or app package to their phone.

In the preferred embodiment, the contents of each text message will then be scanned/filtered for flags and other data contained in the text message: i.e. phone number, alert flag, reply indicator flag, and activity triggers (FIG. 3a). Any recovered phone number, flag, and/or actionable triggers (triggers that will cause the OT application to execute a specific action at a specific time or event) will be stored in specific fields in the record containing the text message. The OT application will review each record stored in the text message table for executable flags and actionable triggers, upon finding one the OT application will execute the associated function(s) when determined appropriate.

In the preferred embodiment the user will be able to accept text messages from devices using an Obexi Text application and device from devices not using an Obexi Text application. Non OT users can manually enter a flag or actionable trigger. that into text messages being sent from their phone that does not have a copy of the Obexi Text application.

The Obexi Text (OT) application utilizing its data storage structure and configuration will enable users to screen incoming text message and sort them according to preference: read & keep, look at later, or auto delete. OT can utilize the built-in clock/calendar of the phone to delete unwanted text message and alert user to specific time sensitive events and communications. When a text message is received by a phone running the OT application, the text message will be scanned/filtered for flags and actionable triggers. Whatever is detected (flag or actionable trigger) will be stored in a specific field, flags go into the flag field and actionable trigger goes into the actionable trigger field. The programming of the OT application will then be able to search the table of text message content and perform activity that are requested of the text message.

When the user gets information (i.e. gate and departure times) from a bus station via OT text format, the OT system format has an alert time flag that will enable the OT application to beep when it gets within a certain time (i.e. 2 hours of departure). This functionality would serve as a reminder to the user of their interest in the catching a bus to a destination (see FIG. 4). Obexi Text, is designed to be interactive with the phone with regards to data it captures, able to dial capture phone number and detect various flags and indicators. The time/Clock linkage can also be used to trigger automatic erasure of un-wanted communication(s). A message can be send to an OT user's phone with a self-erasure “time date flag” in it, prompting the OT application to remove the message after a set time period. The OT application can also remove un-wanted text message if the user did not flag the message to be saved: all text message that have not been flagged to be saved will be automatically deleted after a set time period (10 days). This would allow OT to remove old/outdated ads, unwanted text messages, services being offered by store and companies to consumers, and useless communications.

The Obexi Text application captured information contained in incoming and outgoing text messages and stored this information in a searchable data base file on the phone. Due to the nature of the incoming text messages being stored in field in a table, the OT application allows the user to stroll through all of the new text messages on a single screen. All of the new/un-viewed text message are displayed in an efficient and convenient manner. The OT application will display the name, phone number, first field (1-35 characters) of the received text message. The user can choose to open the text message and read it entire contents, skip it and go on to see the next text message, or instantly call the sender to speak with them. This one location handles all of the text message received by the OT application. If the OT application user just scrolls through the text message and does not open them, they will be there when next the user looks at the OT application. The message will remain in the single field (line) view mode until the text message is opened. The user can save the message for later viewing or leave it in the un-view/un open mode. Once a text message is open so that the user can view its full contents, it will be remove from the view mode and be stored in the table in the database file. If the user does not open the text message the, it will remain on display for 10 days, and then it will be auto-deleted. While a message is stored in the OT application database, it can be viewed by using the module. The search module will allow the user to search by a variety of field: including granular.

In an alternate embodiment, the ad/message erasure/removal can be partial, that is some of the original message is retained, and anything that is time sensitive (expire with time) can be removed. When a sale ends, OT could retain the basic information (aka base information) the store name, phone number, address, and web-link, but rid the phone of the outdated sales material (see FIG. 5). OT breaks up the data that it transmits and capture into two categories: “base information: information that is kept” and “removable information: that is time sensitive”.

In an alternative embodiment of the cloud version of the OT application, the storage process can involve the download of advertising. The advertising can be text, audio, graphic or some combination of the three will be display on the screen as the user starts to use the application. In this embodiment, when the user first sets up their cloud account, they will be able to indicate what types of ads they are interested in from a selection offered. This will encourage the user to pay more attention to the ads displayed, and allow the advertisers to know that there is some interest in the product by the user.

In another alternative embodiment, advertiser agents/agencies can send ads that pop up as single line of text, or as full OT message. Both forms of ads will have their top line (first 35 text characters) pop up in the screen window of the application, and the phone users can do as they want: read, keep, or decide not to look at the ad. If the user elects to not look at the ad, it will be deleted within 10 minutes, not 10 days.

In another alternative embodiment, OT application can restrict by code unauthorized advertiser ads from appearing on OT display screen. This will give OT a proprietary revenue platform.

OT enhancement will allow the user's phone to automatically recognize a code word in the start of the Text Message that will indicate a request for acknowledgement of an incoming Text Message. Each Text Message is passed through a filter to discern the presence of the acknowledgment code (FIG. 3a). If the code is present, the OT application will give two notifications. The first notification will be an acknowledgement of receiving the Text Message, and the second acknowledgement will be sent when the OT application user open text message from a single line mode to a full content viewing mode (to read the Text Message). This enhancement will allow a sender to know not only that the text message has be received, but that their Text Message has actually been read. Once a Text Message is acknowledge as being read, the OT app will Tag the Message to make it stand out. This will allow the user to know that his phone has acknowledge this specific Text Message, and that attention should be given to it. In one embodiment all acknowledged Text Messages will be color code, to make them stand out from other Text Messages. The code for sending acknowledgement is editable by the user, enabling the user/a company to set a code that will allow text message between employee regarding work to be automatically responded to.

In an alternative embodiment the need for a text message to be acknowledged might me indicated by an audio tone, vibration, coloration of the message or some combination of the three. The OT acknowledgement code is programmable by the user. This will allow the user to personalize the acknowledgement code if desired. This will allow companies to send business text and get a response back that tells them when the text is received and when it is read. By customizing the acknowledgement code, you will not be responding to every Text Message that arrives in your phone with a standardize acknowledgement code.

Advertising on OT will consist of specially constructed ads. The ads will fit in the first Data field of the OT record; therefore, it will appear in the pop-up/screening section of the OT application. This will allow the user to decide if they are interested in the offer or want nothing to do with it. The ads will have a shorten life expectancy than a text message, if tagged for deletion it will immediately move into background and be deleted after 10 minutes.

The information capture by the OT application will be displayed according to a predetermined formatted for optimum use and viewing: i.e. name, phone number, address, web-link or email, any message text, and the editable search key (FIG. 3). The information may arrive with the search key being set to “Information”. The phone owner can key edit the search key to “Family” if the information contains phone and address of a relative. This will allow the user in the future to be able to retrieve the information not only by name, but also by searching under Family”.

In the preferred embodiment of OT, directory assistance (DA) information relating to a doctor's office is transmitted to a phone. This communication type is “Ad-Related” because the information is related to a professional setting. The information capture by the OT application on the phone is formatted in a manner that displays of the doctor's name, phone number, office hours, and an editable search key (see FIG. 3). The information may arrive with the search key being set to “Information”. The user can edit the search key to say “Doctor” (see FIG. 5).

The innovation of an editable search key will allow the user to see all of the phone numbers in the phone that relate to relatives. If the user does not see the phone number that they are seeking (i.e. their Uncle Sam), they may see another relative (i.e. cousin FICA) who does have the desired phone number (Uncle Sam phone number). The utilization of a searchable database format to store information will improve what can be done with information capture/transmitted over a text messaging communication network. Each saved communication is known as a “Communication Session”, and each session can contain a set number of lines of texts. The ability to isolate individual communication sessions will enable specific functionalities to be added to any of the saved communication sessions. Instead of retrieving information by strolling through a sequential string of text communications that are annotated only by date. OT will provide the user with 5 different methods to search text messages stored in the text message table: Name of Sender, Editable Search Key, Phone Number of Sender, Status of Text Message, and Granular (all fields of the text message for a specific word or combination of words). searchable keyword in addition to date. OT users can store information in categories on their cell phone, or under unique code that can be searched and quickly retrieved.

In the preferred embodiment of OT, the Obexi Text application create a new data module called a Communication Session (CS). A CS consist of a query and the reply to the query (FIG. 2). OT application was designed around that fact that most text messages are maxed out at 140 characters. Each text message generated in the OT application has a maximum length of 140 characters, and a countdown counter helps the user to keep track of how much space they have let as they type out their message. When an incoming text message is received in the OT applications, it gives the responder the opportunity to reply. This reply is stored in the same record as the incoming text message, creating a query and a reply, or what we call a Communication Session (CS). The 140 characters size restraint will help limit excess verbiage, making the communication more succinct. The query and reply text message storage in a single record in the text message table, will allowing OT user search and retrieve specific a specific Text Message and reply at a glance. This will enable searches to be more productive and valuable to the users of Obexi Text both as a resource on the cell phone and a resource in an external database. The export of Communication Sessions to an external database can be singular or collective (many OT users can export CS to a common database for group research).

In another alternative embodiment, an open sharing of Communication Session (CS) data can be stripped of identifying information such as phone number and name, and all CS records from a given source will be given a unique user ID. This will allow the shared downloaded text communication records to be associate with a specific source without revealing source identity.

In another alternate embodiment, the length of the Text messages can be increased beyond 140 characters or decrease below 140 characters.

In the preferred embodiment, the Obexi Text application provides a stable/fixed scrollable display format for received text message. Each of the received text messages will always display a single line of text in a pop-up display in the same portion of the screen, allowing the user to automatically focus on that part of the display and not have to search the screen for sender information, flags, and/or alert indicators as they reviewed received text messages.

The OT application will use an enhanced contact database that allows the user to store multiple contact names in each entry. In a normal/general contact database, the user store one contact name to each entry. In the OT Application there will be two contact database system. The first one allows the allow the user to store one name per entry. In the other contact system, named Skylite, the user can store multiple names (names and their associated phone numbers) in a single entry.

In one embodiment, the Skylite entry with multiple names when selected will display all of the destination names and phone numbers. In an alternate embodiment, the entry can be given a specific name such as “Group 1”, “Group 2, or “The Gang”.

In the preferred embodiment, the Skylite Contact Database can pull contacts from the regular data contact database. This will save time and ensure accuracy in the creation of the Skylite Contact Database. In an alternative embodiment, the Skylite Contact Database may be able to interact with a social media, or professional business type app and download groups of names by pre-assigned categories entries (i.e. a hundred names and phone numbers divided into 12 groups).

When the user of the OT application selects an entry from the Skylite's Contact Database all of the names/destination phone numbers in the entry will receive the same text message. This will enable the user to quickly disseminate information, or conduct conversations with multiple parties at the same time (FIG. 9).

In the preferred embodiment, the Skylite texting can enable a user (FIG. 10, member 4) to conduct multiple independent text conversations with distinct groups at the same time.

In an alternative embodiment, the Skylite texting can determine by an enclosed flag what group the user is receiving a text message from, and if the receiver is communicating to another group that has different members then OT will forward the received text message to the external member (see FIG. 10). Members 1, 2, 3, and 4 are communicating with one another. Member 4 is also communicating with another group consisting member 2a, 3a, and 4a. Whatever member 4 receives or forward goes to everyone: 1, 2, 3, 2a, 3a, and 4a. Whatever text messages members 2a, 3a, and 4a exchange between them, is shared only with member 4, 2a, 3a, and 4a.

### DESCRIPTION OF FIGURES

FIG. 1 illustrates the process by which the contents of a text message is broken down and saved to the fields of a record in a table. Item 1 shows a text message that is generated. Item 2 shows how information contained in a text message is converted into a string, and the string is broken into segments that are stored in fields of a unique record in a table that is used by the Obexi Text application to store all sent and received text messages. Each outgoing text message and each incoming text message and reply are treated as an individual record. Each record is stored in a table that is stored in a database. The three buttons about the text message box will allow the user to send a reply to the text message (Reply button), send a text message to someone else (SMS button), or save the text message on the mobile device in the Obexi Text database of sent and received text messages.

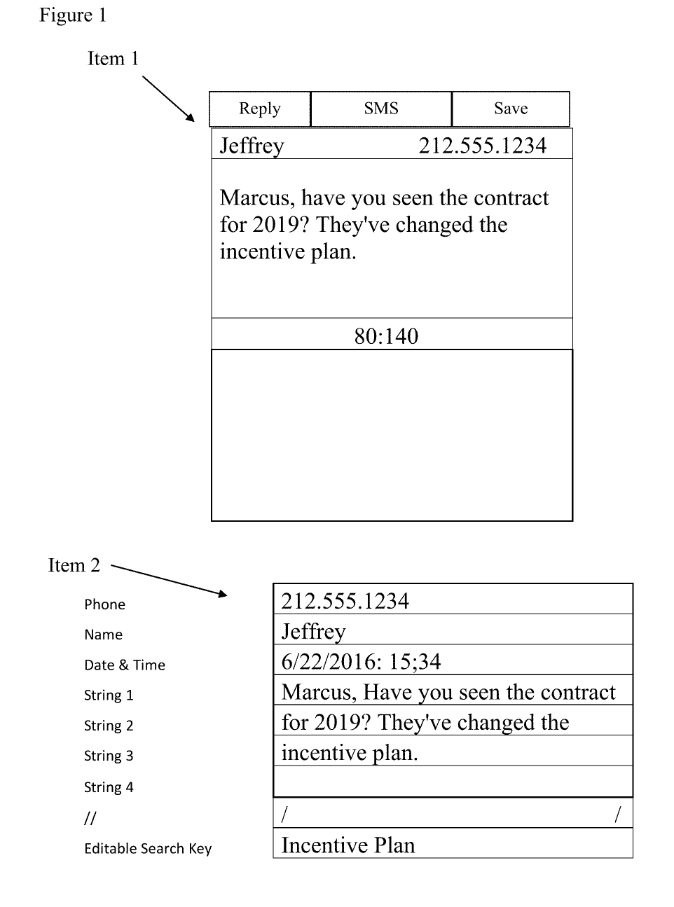

FIG. 2 illustrate that a received text message may that is replied to will have the content of the replied text message and have the content of the received text message stored in the same record in the table used to store all text messages. When the “Reply” button is pressed, the user can enter their text message, and the Obexi Text application will replace the “SMS” button with a “Send” button, enabling the user to forward the reply back to the original message sender. The name and phone number display on the Obexi Text message is actionable, that is the user can click (touch) it and the application will dial the phone number of the originating text message.

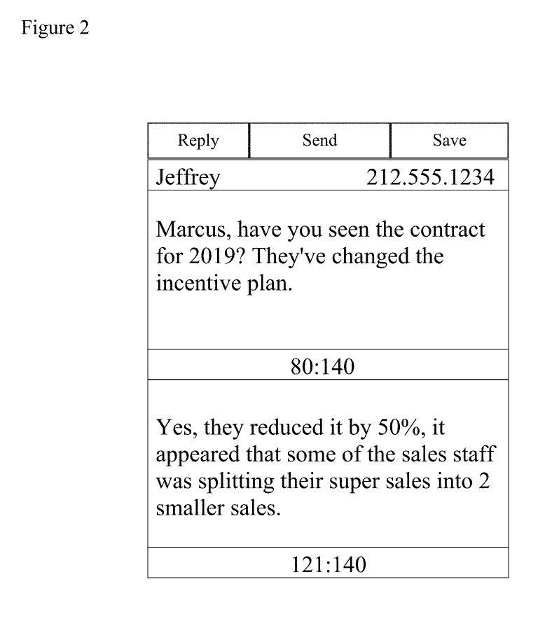

FIG. 3a Illustrates the placement of an Acknowledgement Request” flag in a text message. The “Acknowledgement Request” is a customizable flag, that the user or a company can determine. It is composed of alpha-numeric characters of surrounded on both sides by “#” (at the start and end of the flag): the chosen sequent of alpha-numeric characters. Once an Acknowledgement Request” flag is determined, the specific sequent of alpha-numeric characters are stored in the Set-up. The application can install the Acknowledgement flag with the push/click of a button or by manual input. The received text message will detect the Acknowledgement Request” flag when the message is first received and respond by forward a text message stating that the text message has been received. Once the text message is open/read, the Obexi Text application will send a second text message informing the user that the text message has been read/viewed.

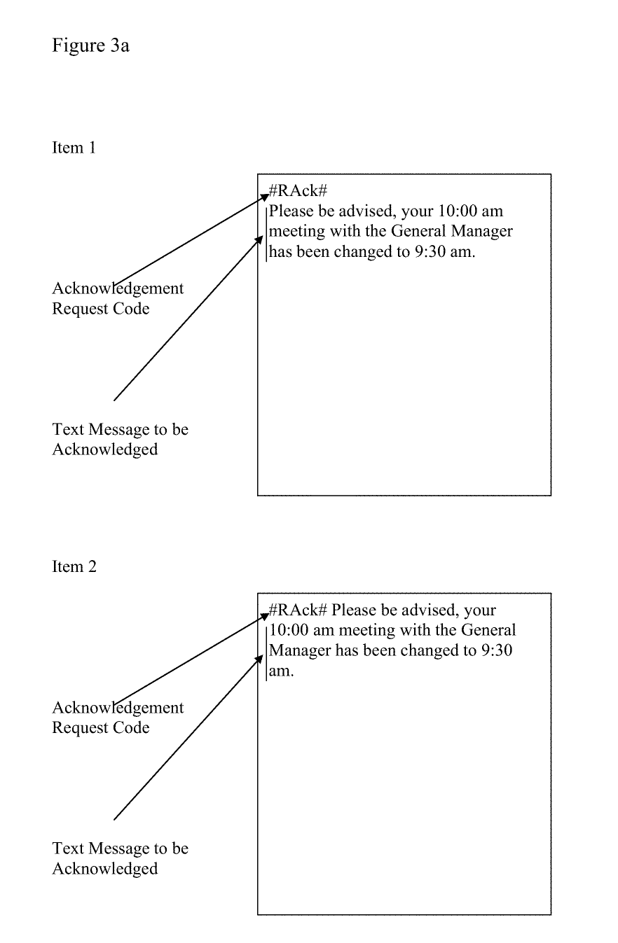

FIG. 3b illustrates how Obexi Text ensures that an acknowledge text message is actually read by the receiver. The Obexi Text application will highlight all text message that were received with a “Acknowledgement Request” flag. This will allow Obexi Text users to immediately recognize messages that should be given a higher priority.

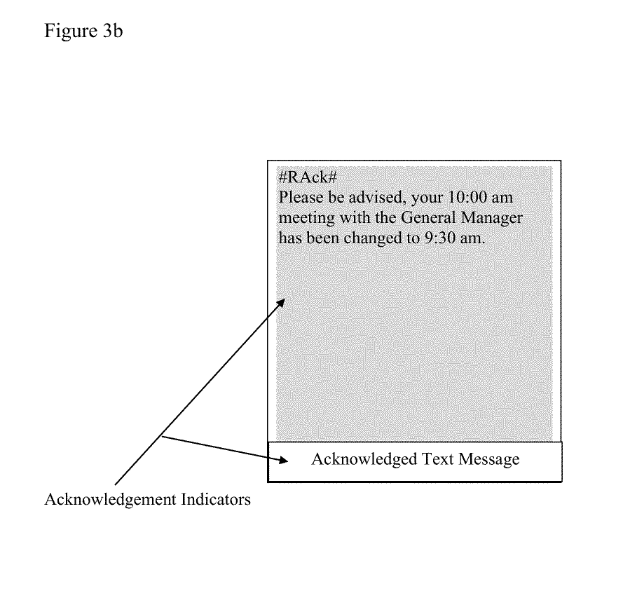

FIG. 4a illustrates how a text message can be forwarded from a private business to a mobile device with Obexi Text application on it.

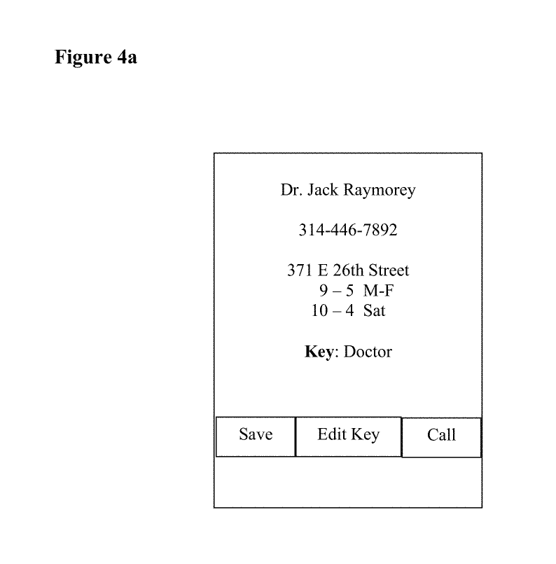

FIG. 4b illustrates how a text message can be forwarded from a bus company to a mobile device with Obexi Text application on it. The information is time sensitive, and will lose some of it's value with the passage of time, therefore components of the message needs to be acted upon in a timely manner (see FIG. 6). The screen also displays options available: editable search key, save the information, and call the call the doctor's office.

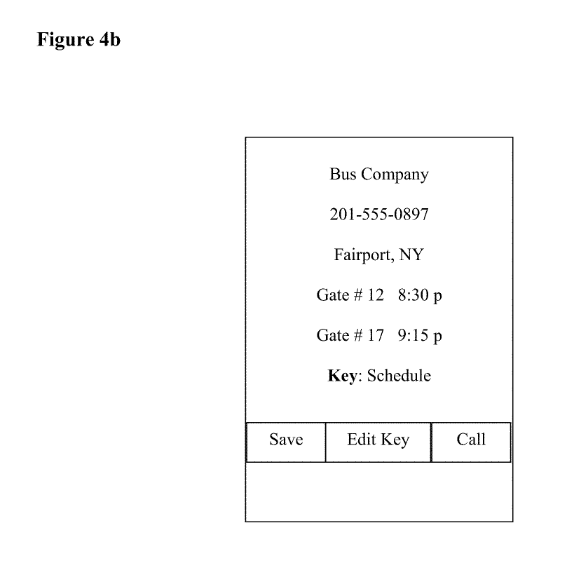

FIG. 5 illustrates the contents of each received text message being broken down and stored in fields in a table.

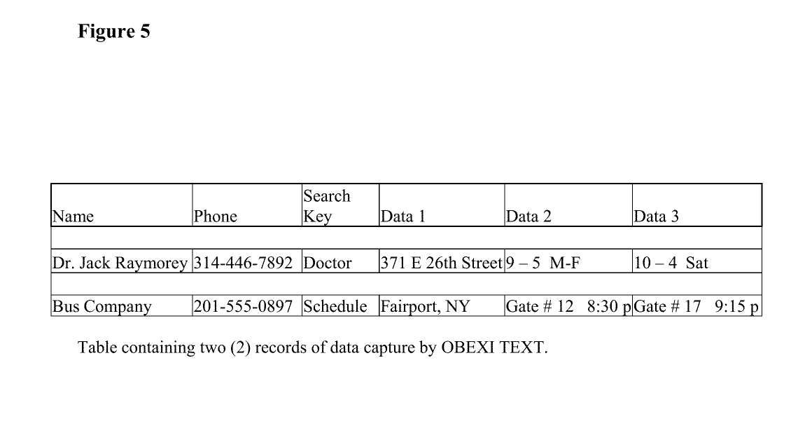

FIG. 6 illustrates Obexi Text application on a mobile device altering the user to upcoming departure time. It is also illustrating the selective removal of part of the message: the “Gate 12 bus at 8:30 is removed. In Item “A” of FIG. 6, the Obexi Text application captures the schedule for the next two buses for Fairport NY. As time passes and it is no longer possible to capture the first bus, the application will remove it from the screen. Being that the departure times are stored in individual fields, it is possible to erase the contents of one fields and not disturb the other stored information in the record. When the departure time approaches, Obexi Text is beep/vibrate to alter the user of the mobile device of the impending departure time. OT will sound an alert when the time indicates that the departure time it with in 1 hour. In one embodiment, once information is obsolete only the base information remains: Company Name, Phone Number will be retained, all other is deleted.

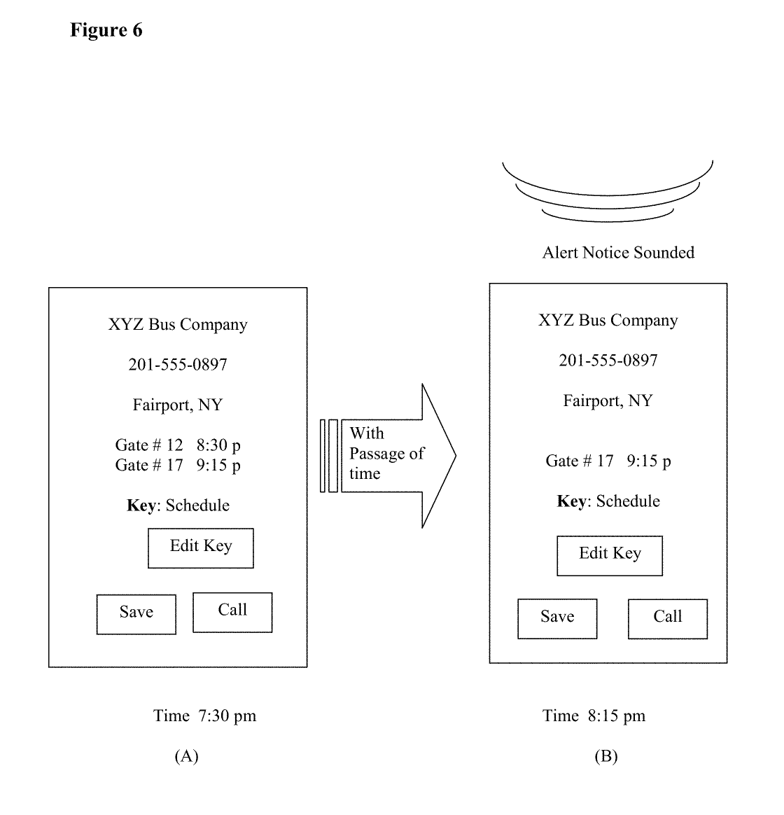

FIG. 7a illustrates Obexi Text application on two mobile devices being able to transmit and receive text messages that are saved in respective database of the application.

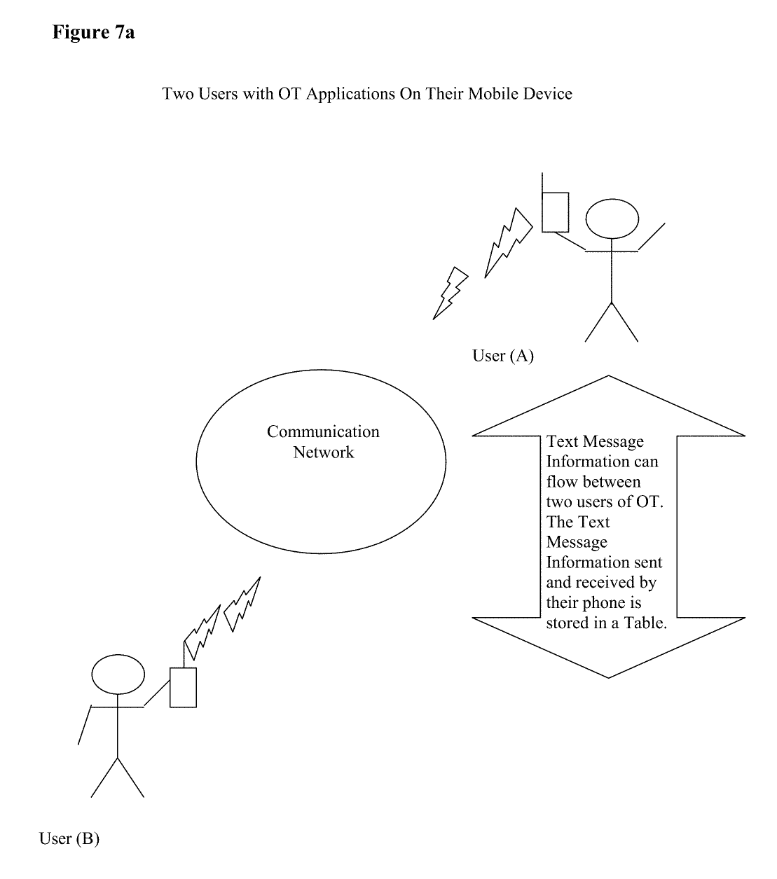

FIG. 7b illustrates Obexi Text application on one of two mobile devices being able to transmit and receive text messages. The mobile device with the Obexi Text application (Item A) is able to receive and send text messages to the mobile device without the Obexi Text application (Item B). The Item B (user without Obexi Text Application) can manual enter alerts flags and “Acknowledgement flag”, but if his phone (mobile device) received a text message with these flags, it would not be able to respond to them. Item A (user with the mobile device running the Obexi Text Application) will be able to respond to manually entered flags from a mobile device without the Obexi Text application.

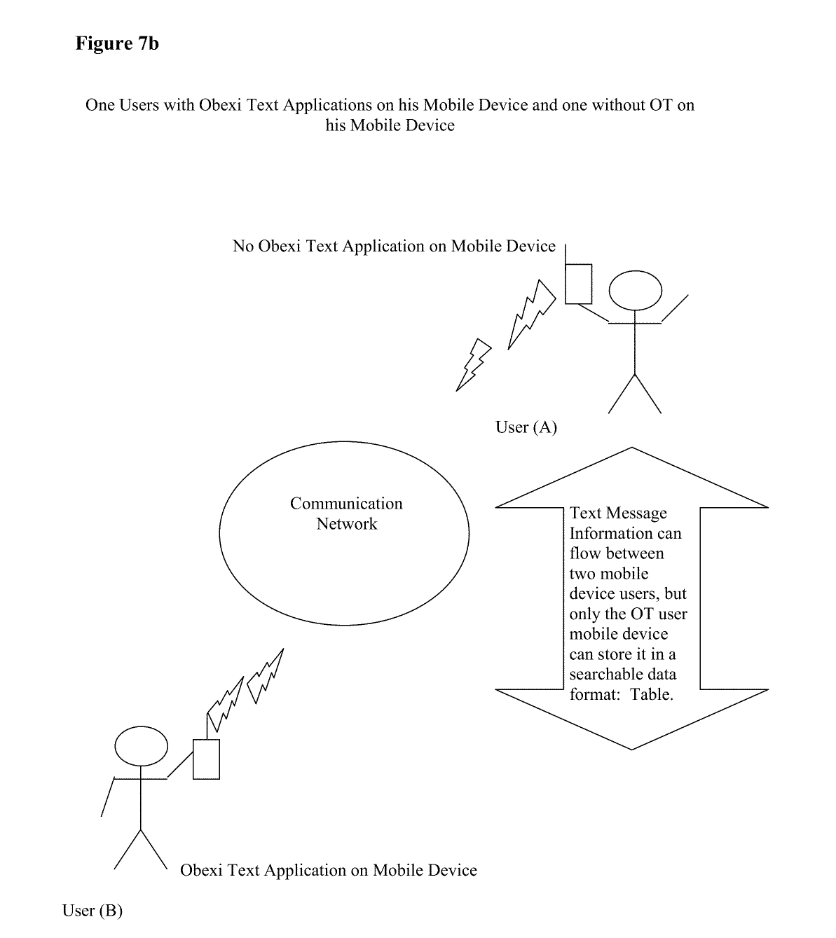

FIG. 7c illustrates Obexi Text application on two mobile devices being able to transmit and receive text messages that are saved in respective database of the application. Each mobile device may elect to export all or part of the contents of the text message table stored in the database to an external central site for share use by members of an organization/company, or by the general public.

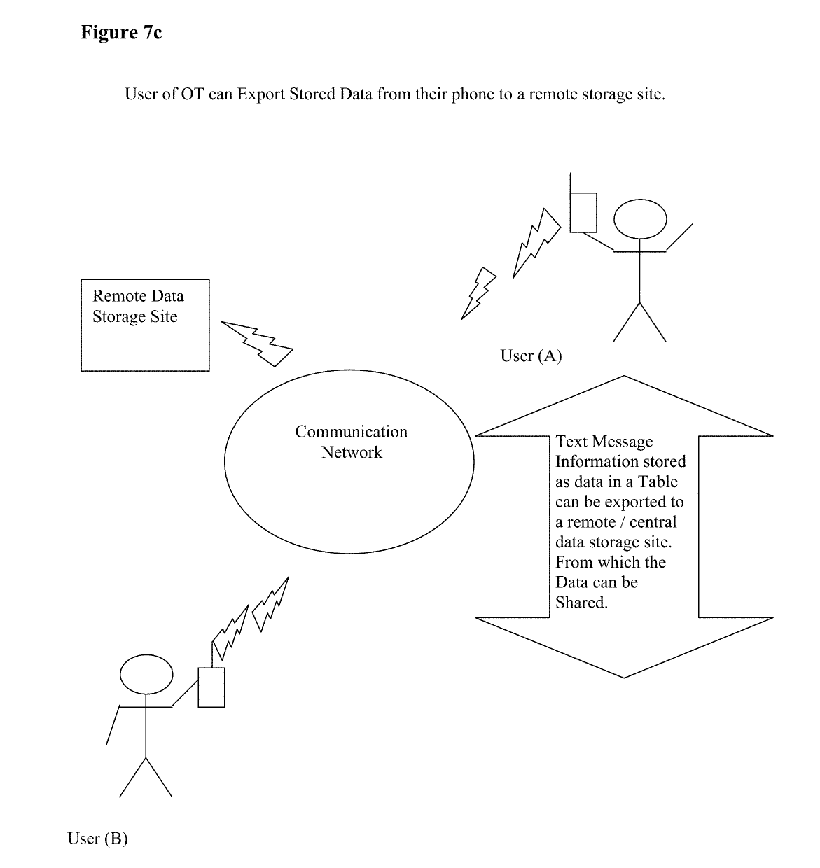

FIG. 8 illustrate an alternative version of Obexi Text application, where every text message is saved to memory as a record a table of sent and received text message. All messages are saved, unless the user specifically clicks on the delete button when viewing the text message. The deletion process will take 10 days to be executed, this will give the user time to change their mind and go back and undelete the text message.

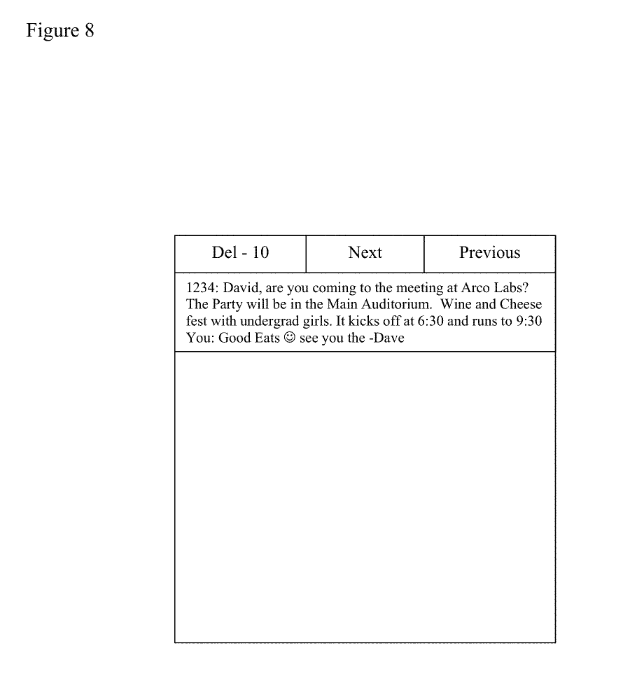

FIG. 9 illustrate four (4) user using the Skylite feature of the Obexi Text application. The users have selected an agreed upon group that includes all of them, from the Skylite Contact database. The using the agreed entry the users are able to exchange text messages that are written once with everyone in the selected group. and forwarded to each user in the entry

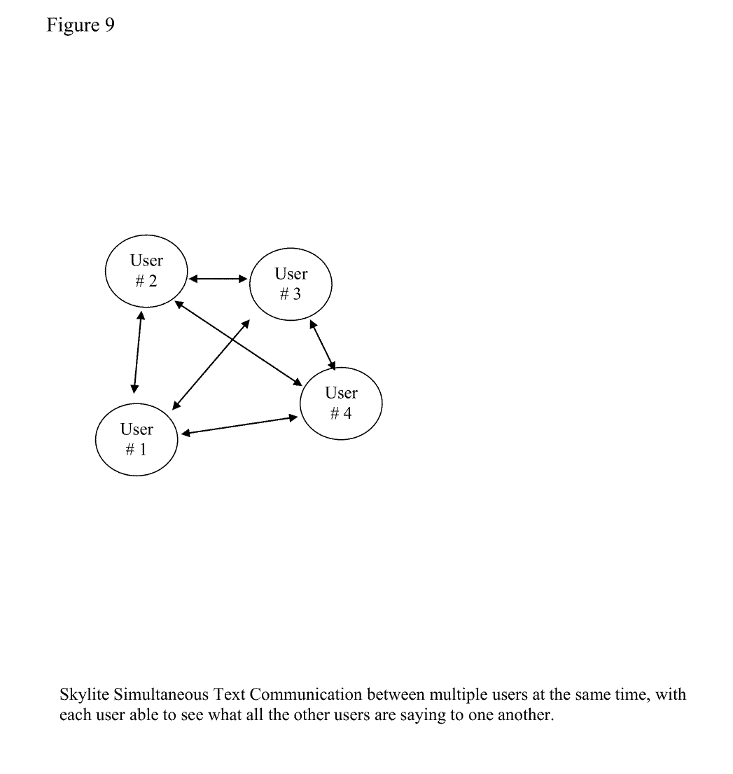

FIG. 10 illustrate four (4) user using the Skylite feature of the Obexi Text application in one group, and one of the 4 users using another group to communicate with three (3) additional users. By selecting different pre-configured groups from the Skylite Contact database, it is possible to rapidly switch between groups of people to share text messages.

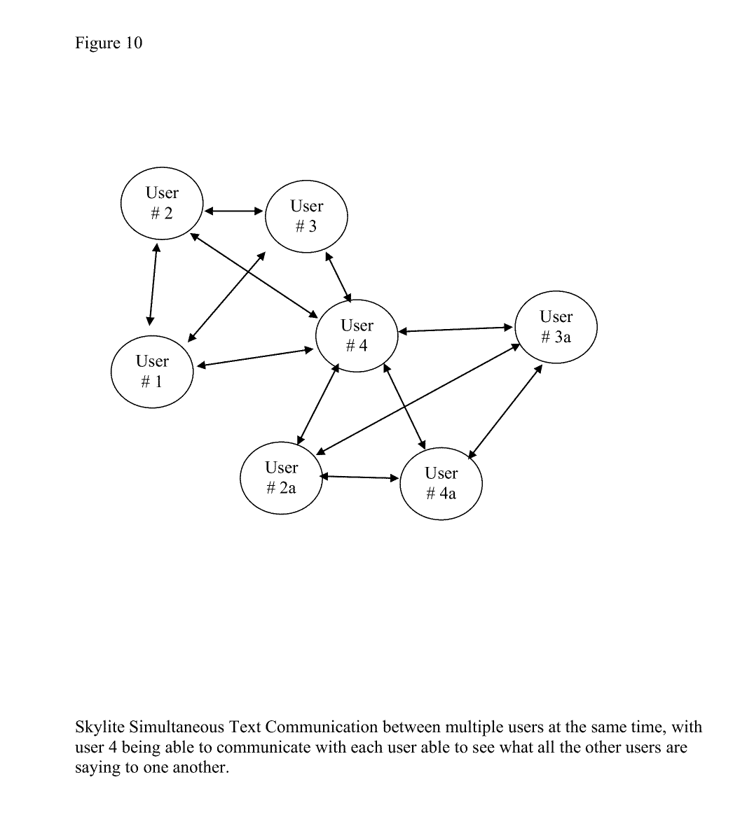

While the disclosure in this patent are specific they are examples of the preferred embodiments, those skilled in the art will appreciate that there are numerous variations and permutations of the above described systems and techniques that fall within the spirit and scope as set forth in the appended claims.

What is claimed:

1. A method, comprising: converting the contents of each transmitted and received text messages into data (information) that can be stored in searchable fields of a record, and said record being stored in a table on a mobile device;

2. The method of claim 1, wherein the contents generated from the text message can autonomously interact with the data (information) stored fields of in the record and the records stored in table;

3. The method of claim 2, wherein a select portion of the store information from the text message is display in a format that allow quick review and management of accumulating information from received and sent text messages;

4. The method of claim 3, wherein the content of a text messages stored in the table can be viewed as relational data, enabling new insight to be drawn from text messaging between a variety of sources;

5. The method of claim 4, wherein the content of text message stored in a record can alert the user of the mobile device to an impending meeting, event, or appointment;

6. The method of claim 5, wherein data (information) stored in the table can be searched by a variety of criteria;

7. The method of claim 6, wherein data from a variety of sources is packaged such that a received text message and the reply to the received text message are presented in an anonymous sharable format, enabling research to track how information is moved about in day to day communication.

8. A mobile device-implemented method comprising: software for storing and retrieving the contents of text messages that were converted into data that is stored fields of a record, said record can be searched and grouped within a table according the contents of the fields contained in the record, exportation of the searchable (records) in a table generated from collection of incoming and outgoing text messages to a remotely located central processing center computer(s), provides a new line of insight to what is communicated;

9. The method of claim 8, wherein a specific temporal event cited in a text message and stored as information in a field in a record can be recognized and trigger activity in said mobile device;

10. The method of claim 9, wherein the contents of a received text messages are lined-up by date and time received and packaged in a manner that allows for quick and specific review of their content;

11. The method of claim 10, wherein text messages deem un-important or not desirable for saving will be automatically removed from record storage on mobile device;

12. The method of claim 10, wherein the content of a field in one record can affect the contents of one or more fields in the same record, allowing the time relate field to trigger the removal of all outdated information in other fields of the record.

13. The method of claim 12, wherein the content of all the records in database can be search by a specific field to retrieve all records within the database with the same searched for item regardless of the origin of the text message that the record was created from;

14. The method of claim 8, wherein the mobile device able to store and retrieve records in database file from a cloud base computer system is also able to retrieve media files from a third party that is also stored on a cloud base computer system.

15. The method of claim 14, wherein the contents of a received text messages are lined-up by date and time received and packaged in a manner that allows for quick and specific review of their content;

16. A mobile device-implemented method comprising: software for storing and retrieving text messages in a record format in searchable database files on remotely located central processing center computers, and have the mobile device able to access, download, and view third-party media files from the remotely located central processing center computers.

17. The method of claim 16, wherein the third-party media can be an image file that will be briefly displayed to the mobile device user.

18. The method of claim 16, wherein the software stored on the mobile device can search fields of the records in the database and interactive with them base on of the mobile device internal clock function, enabling the mobile device to trigger activities base on a time setting in a specific field.

19. The method of claim 18, wherein the content of a field in one record can affect the contents of one or more fields in the same record, allowing the time relate field to trigger the removal of all outdated information in other fields of the record.

20. The method of claim 16, wherein the content of all the records in database can be search by a specific field to retrieve all records within the database with the same
